(19) United States
(12) Patent Application Publication
(10) Pub. No.: US 2021/0006478 A1
(43) Pub. Date: Jan. 7, 2021

(54) DISTRIBUTED COMPUTING PLATFORM SERVICE MANAGEMENT

(71) Applicant: Trixta, Inc., Phoenix, AZ (US)

(72) Inventor: Mark Levitt, Foster City, CA (US)

(21) Appl. No.: 16/644,470

(22) PCT Filed: Sep. 5, 2018
(86) PCT No.: PCT/IB2018/056775

§ 371 Date: Mar. 4, 2020

Related U.S. Application Data
(60) Provisional application No. 62/554,504, filed on Sep. 5, 2017.

(51) Int. Cl. H04L 12/24; G06N 20/00; H04L 12/26; H04L 29/06

(52) U.S. Cl. CPC H04L 41/5096; H04L 41/5009; H04L 67/40; G06N 20/00; H04L 43/0817; H04L 41/5006

(57) ABSTRACT

A computer-implemented method and associated system is provided for distributed computing platform service management. The method is conducted by an operating system executing on a distributed computing platform accessible to client devices of an organization. The distributed computing platform facilitates access to a centralized or decentralized distributed service by the client devices. The method includes obtaining service level parameters for the service, quantifying risks associated with each parameter and generating a parametric distribution based on the quantified risks. Access is provided to the parametric distribution. The level of service associated with the distributed service is monitored via a centralized or decentralized component adapter. In response to detecting that a service level parameter is breached, a notification of the breach is transmitted to the digital platform. The notification may trigger connection of an alternative centralized or decentralized distributed service to the client devices.

### CROSS-REFERENCE TO RELATED APPLICATIONS

This application claims priority from U.S. provisional patent application No. 62/554,504 filed on 5 Sep. 2017, which is incorporated by reference herein.

### FIELD OF THE INVENTION

This invention relates to service level risk management, in particular, to a system and method for service level risk management in a computing environment which interfaces with centralized and decentralized services. It finds particular application, although not exclusive, in distributed computing platforms.

### BACKGROUND TO THE INVENTION

Computing technology has traditionally been of a centralized nature where particular infrastructure, software or services are controlled by particular, discrete entities. There are however risks associated with centralized computing platforms, such as security vulnerabilities and consequences of downtime.

Possibly in response to these risks, there is an increasing trend towards decentralized systems which take control of the infrastructure, software or services away from individual entities and instead place this in the hands of a group of peers.

One example of a decentralized computing system which is becoming ubiquitous is blockchain technology. Blockchain technology enables a database to be shared by multiple nodes. Individual blocks contain entries in the database (typically describing a transaction) as well as a hash of the previous block. This has the effect of creating a chain of blocks from the genesis block to the current block and each block is guaranteed to come after the previous block chronologically because the previous block's hash would otherwise not be known. Each block is also computationally impractical to modify once it has been in the chain for a while because every block after it would also have to be regenerated. New blocks, containing new entries in the database, are serialized using a proof of work or other suitable scheme and are broadcast to all nodes on the network using, for example, a flood protocol.

The cryptographic and peer-to-peer properties make blockchain technology secure, trustworthy and typically more reliable than corresponding centralized models. Although used initially in cryptocurrencies, such as bitcoin, blockchain technology is increasingly being extended to a plethora of different applications.

For example, the concept of smart contracts which rely on blockchain technology is emerging. Smart contracts are made up of executable computer program code which generally cause specific actions to be taken once specific conditions have been met. By using blockchain technology, smart contracts aim to provide security that is superior to traditional contract law. One of the more prominent blockchain-based smart contracting implementations is that provided by Ethereum (Ethereum is a trademark of the Ethereum Foundation).

Smart contracting has in turn lead to the emergence of so-called decentralized applications, or “dApps”. Decentralized applications may enable developers to create markets, store registries of debts or promises, move funds in accordance with instructions given long in the past (e.g. a will or a futures contract), etc., without a middle man and with reduced counterparty risk.

Decentralized computing presents a number of new opportunities. However, there remain challenges in developing software which makes use of this technology. Further, reliance on centralized computing systems for certain applications is likely to continue for the foreseeable future and it may be desirable to address the chasm that exists between centralized and decentralized computing systems. Additionally, higher risks associated with centralized computing, especially cloud-based solutions, may retard widespread adoption thereof. These risks may include, for example, that each centralized service used may represent a single point of system failure, depending on the critical nature of the service.

Accordingly, there is scope for improvement.

The preceding discussion of the background to the invention is intended only to facilitate an understanding of the present invention. It should be appreciated that the discussion is not an acknowledgment or admission that any of the material referred to was part of the common general knowledge in the art as at the priority date of the application.

### SUMMARY OF THE INVENTION

In accordance with an aspect of the invention there is provided a computer-implemented method conducted by an operating system executing on a distributed computing platform including a processor and a memory, wherein the distributed computing platform is accessible to client devices of an organization via a communication network and wherein the distributed computing platform facilitates access to a centralized or decentralized distributed service by the client devices, the service being provided by an external third party, the method comprising:
obtaining service level parameters for the service, including estimating parameters of an expected service level based on historical data stored in the memory;
quantifying risks associated with each parameter and generating a parametric distribution based on the quantified risks;
providing access to the parametric distribution to a digital platform, the digital platform being accessible to external third parties;
monitoring the level of service associated with the distributed service via a centralized or decentralized component adapter; and,
in response to detecting that a service level parameter is breached, transmitting a notification of the breach to the digital platform for on forwarding to a selected external third party, the notification being configured to trigger connection of an alternative centralized or decentralized distributed service to the client devices.

Further features provide for the step of obtaining service level parameters for the service to include establishing a connection to an Application Programming Interface (API) provided by the service, calling an API function associated with at least one service level parameter, and obtaining the at least one service level parameter from a response of the service in reaction to the API function call.

Still further features provide for the at least one service level parameter to be obtained from one or more of the group consisting of: a completion time of the response, a return value received in reaction to the API function call, and a failure rate of the API function call; and for the method to include maintaining a log of one or more of API function calls, data included in API function calls, and data returned from an API function call.

Even further features provide for the at least one service level parameter to be obtained by extracting service level agreement data extracted from an agreement in which the external third party agrees to provide a level of service defined in terms of the service level parameters.

Further features provide for quantifying risks to include quantifying the potential losses in dealing with the service by using a machine learning algorithm to dynamically estimate consequences associated with the service level parameters; for generating a parametric distribution to include using a machine learning algorithm dynamically to estimate operational consequences associated with the service level parameters; and for monitoring the level of service associated with the distributed service to include one or more of: monitoring service uptime, monitoring service downtime, and executing a machine learning algorithm configured to observe delivery patterns associated with the service and to determine an expected service lead time based on the observed delivery patterns.

A further feature provides for the notification to be configured to trigger connection of an alternative centralized or decentralized distributed service to the client devices, including dynamically identifying another external third party providing the same service and automatically switching connection to the identified service according to configured rules.

Further features provide for the method to further include arbitrating to evaluate one or more service level parameters and to identify the service which best meets these requirements, including quantifying a breach in a service level parameter and quantifying a cost of switching from one service to another.

Still further features provide for the service to be configured for machine-to-machine interaction over a communication network; for the decentralized service to be a blockchain-based or peer-to-peer-based service; and for the centralized service to be a cloud-based or remotely accessible service.

A further features provides for the method to be used in at least partial execution of a smart contract.

A still further feature provides for the method to include providing a user interface associated with the distributed computing platform for monitoring and/or developing centralized and/or decentralized software applications.

Further features provide for the method to include dynamically creating an insurance product in respect of the quantified risks including determining a quantum and a premium payable in return for the insurance product; for the method to include dynamically activating the insurance product; for the method to include dynamically updating the insurance product in response to changes detected in the data relating to the monitored level of service; and, for dynamically updating the insurance product to include updating the insurance product in real-time and without human intervention.

A still further feature provides for generating the parametric distribution based on the quantified risks to include generating a statistical model usable in creating an insurance product.

A yet further feature provides for the method to include positing the parametric distribution to a digital insurance market place on which external insurance providers dynamically bid to provide an insurance product in respect of the quantified risks.

In accordance with a further aspect of the invention there is provided system including a distributed computing platform having a memory for storing computer-readable program code and a processor for executing the computer-readable program code, the distributed computing platform being accessible to client devices of an organization via a communication network and the distributed computing platform configured to facilitate access to a centralized or decentralized distributed service by the client devices, the service being provided by an external third party, the system comprising:
a service level parameter obtaining component for obtaining service level parameters for the service;
a risk quantifying component for quantifying risks associated with each parameter;
a parametric distribution generating component for generating a parametric distribution based on the quantified risks;
an access component for providing access to the parametric distribution to a digital platform, the digital platform being remotely accessible to external third parties;
a centralized component adapter for interfacing with centralized services;
a decentralized component adapter for interfacing with decentralized services;
a service level monitoring component for monitoring the level of service associated with the distributed service via the centralized or decentralized component adapter;
a breach detection component for detecting that a service level parameter is breached; and
an action component for transmitting a notification of the breach to the remotely accessible digital platform for on forwarding to a selected external third party, the notification being configured to trigger connection of an alternative centralized or decentralized distributed service to the client devices.

Further features provide for the service level parameter obtaining component to include an Application Programming Interface (API) component for calling an API function associated with at least one service level parameter, and obtaining the at least one service level parameter from a response of the service in reaction to the API function call; and for the system to include data storage for a log of one or more of API function calls, data included in API function calls, and data returned from an API function call.

Still further features provide for the service level parameter obtaining component to include an extracting component for extracting service level agreement data extracted from an agreement in which the external third party agrees to provide a level of service defined in terms of the service level parameters; for the risk quantifying component to include quantifying the potential losses in dealing with the service by using a machine learning algorithm to dynamically estimate consequences associated with the service level parameters; and for the parametric distribution generating component to include using a machine learning algorithm dynamically to estimate operational consequences associated with the service level parameters.

Even further features provide for the notification to be configured to trigger connection of an alternative centralized or decentralized distributed service to the client devices and for the system to include a service switching component for dynamically identifying another external third party providing the same service and automatically switching connection to the identified service according to configured rules.

A further feature provides for the system to include an arbitrating engine to evaluate one or more service level parameters and to identify the service which best meets these requirements, including quantifying a breach in a service level parameter and quantifying a cost of switching from one service to another.

Further features provide for the service to be configured for machine-to-machine interaction over a communication network; for the decentralized service to be a blockchain-based or peer-to-peer-based service; and for the centralized service to be a cloud-based or remotely accessible service.

A further feature provides for the system to include a smart contract design tool and using the service in at least partial execution of a smart contract.

A still further feature provide for the system to include a user interface associated with the distributed computing platform for monitoring and/or developing centralized and/or decentralized software applications.

In a further aspect of the invention there is provided a computer program product for service level risk management to be conducted by an operating system executing on a distributed computing platform, wherein the distributed computing platform is accessible to client devices of an organization via a communication network and wherein the distributed computing platform facilitates access to a centralized or decentralized distributed service by the client devices, the service being provided by an external third party, the computer program product comprising a computer-readable medium having stored computer-readable program code for performing the steps of:
obtaining service level parameters for the service, including estimating parameters of an expected service level based on historical data stored in the memory;
quantifying risks associated with each parameter and generating a parametric distribution based on the quantified risks;
providing access to the parametric distribution to a digital platform, the digital platform being accessible to external third parties;
monitoring the level of service associated with the distributed service via a centralized or decentralized component adapter; and,
in response to detecting that a service level parameter is breached, transmitting a notification of the breach to the digital platform for on forwarding to a selected external third party, the notification being configured to trigger connection of an alternative centralized or decentralized distributed service to the client devices.

Further features provide for the computer-readable medium to be a non-transitory computer-readable medium and for the computer-readable program code to be executable by a processing circuit.

Embodiments of the invention will now be described, by way of example only, with reference to the accompanying drawings.

### BRIEF DESCRIPTION OF THE DRAWINGS

In the drawings:

FIG. 1 is a schematic diagram which illustrates an exemplary system in which aspects of this disclosure may be implemented;

FIG. 2A is a block diagram which illustrates components of an exemplary operating system described herein;

FIG. 2B is a block diagram which illustrates components of a parameterized service level agreement management tool described herein;

FIG. 3 is a flow diagram which illustrates an exemplary method for service level risk management;

FIG. 4 is a schematic diagram which illustrates an example user interface of a visual editor described herein;

FIG. 5 is a schematic diagram which illustrates an example of a workflow created using the visual editor;

FIG. 6 is a schematic diagram which illustrates an exemplary workflow block; and

FIG. 7 illustrates an example of a computing device in which various aspects of the disclosure may be implemented.

### DETAILED DESCRIPTION WITH REFERENCE TO THE DRAWINGS

Aspects of this disclosure include a computer-implemented method conducted by an operating system executing on a distributed computing platform that is accessible to client devices of an organization.

The term “services” as used herein should be broadly construed to include distributed services accessible via a communication network. The services may be in the form of or resemble software applications. The services may be configured for machine-to-machine interaction over the communication network and may be centralized or decentralized in nature. Exemplary decentralized services may include blockchain-based or peer-to-peer-based services while exemplary centralized services may include cloud-based or otherwise remotely accessible services.

The method may be used to monitor services provided by a third party by detecting (or anticipating) a breach in service level parameters of the particular service. The method may obtain such service level parameters for the service and quantify risks associated with each parameter. The method may be used to generate a parametric distribution based on these quantified risks and then provide access to the parametric distribution to a digital platform, the latter being remotely accessible to external third parties.

The method may monitor the level of service associated with the distributed service via centralized and decentralized component adapters. If a breach in the service level parameter of a particular service is detected (or anticipated), notification may be transmitted to the digital platform which may, in turn, be forwarded to an external third party. This may trigger the connection of an alternative centralized or decentralized distributed service to the client devices. This may remedy the breach and may provide for continued system operation, having replaced the relevant service in breach of its service level parameters.

The method may be executed on an operating system for interfacing with centralized systems and applications (generally “services”) as well as decentralized systems and applications (generally “services”) is described herein. The described operating system may be configured to provide a user interface which facilitates the development of centralized and/or decentralized software applications (or services).

A development environment is described herein which may be configured to enable an organization to connect to multiple software applications and systems that may be cloud- and/or Internet-based and which may be centralized or decentralized. Aspects of this disclosure provide software development tools arranged to build and operate a decentralized organization. Aspects of the disclosure may be directed towards software development tools specifically arranged to build and operate a decentralized, cryptocurrency token-based organization. Software development tools which are visual-based and which are, to a large extent and particularly from the perspective of the developer making use of the tools, codeless in nature may be provided. Aspects of this disclosure may enable visual layer abstraction to reduce complexity which may be associated with connecting to third party applications, services and systems.

Aspects of this disclosure may further relate to a system for service level risk management in a computing environment which interfaces with centralized and decentralized services.

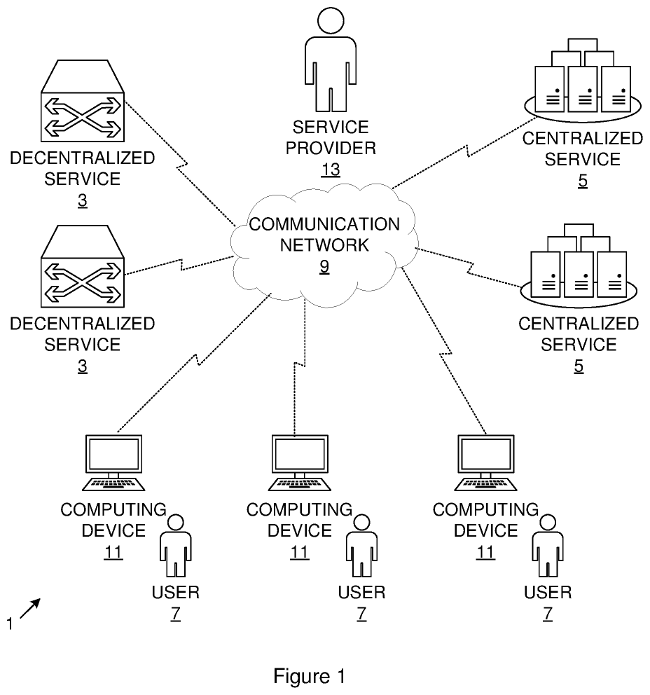

FIG. 1 is a schematic diagram which illustrates an exemplary system (1) in which aspects of this disclosure may be implemented. The system (1) may include a number of decentralized services (3) provided by external third parties and a number of centralized services (5) provided by external third parties. The system (1) may include a number of users (7) who may want to make use of one or more of the centralized and decentralized services (3, 5). The users (7) may be individuals or entities and may access these services (3, 5) by way of a communication network (9), such as the Internet, and suitable computing device (11). The system (1) may further include a service provider (13), being the entity that develops, maintains and/or provides the operating system and associated methods described herein. The users (7) may use the operating system provided by the service provider (13) in order to make use of the centralized and decentralized services (3, 5), to develop their own services, and the like.

The users (7), third parties and service provider (13) may provide and use services, as the case may be, in exchange for value. Value may be exchanged using one or more conventional fiat currencies (e.g. the US dollar) or using one or more cryptocurrencies (e.g. bitcoin, litecoin, etc.).

In some implementations, the service provider (13) may offer its own cryptocoin (a token usable in a particular cryptocurrency system). Users (7) may purchase this cryptocoin from the service provider in order to pay for external third party services. The service provider may in turn pay for the services provided by the external third parties on behalf of the users (7). The service provider (13) may accordingly handle multiple aspects of working with third party services. In some cases, the service provider (13) may purchase external third party services in volume at discount, while charging a higher price to the users (7). The service provider (13) may select between multitudes of services in order to provide the best service to the users (7). In some cases, the service provider (13) may offer its own services in competition with those provided by external third parties. The service provider (13) may abstract the use of services to simplify the software development process of the user (7).

In some cases, users (7) may wish to raise funds through a so-called initial coin offering (ICO) in which they mint a cryptocoin and sell these cryptocoins to interested parties, typically in exchange for the service that they provide or will provide in the future. Aspects described herein may enable users to mint cryptocoins and/or so-called ‘soft’ currencies (which may not be tradable) that can be used to incentivise customers of theirs. Aspects described herein may further enable the creation of ‘near-currencies’ that can be used to create dynamic metrics around users and their activities. An example of this is the notion of membership tiers.

Typically in an ICO, an organization that desires to raise funding will mint their own cryptocurrency and establish a smart contract setting out the terms of the ICO. For every payment (typically in the form of a smart contract coin such as Ether) sent to the ICO organization's wallet, the smart contract would automatically send back this newly minted cryptocoin that would give people special access to the platform plus act as equity in the network. The new cryptocurrency may be created on a protocol such as Counterparty, Ethereum, or Openledger. A value may be determined by the organization behind the ICO (e.g. based on what they think the network is worth at its current stage). Any business that is token-operated requires an exchange where tokens can be bought and sold. This creates a fluid environment where token holders can liquidate their assets in a few seconds or minutes. Then, via price dynamics determined by market supply and demand, the value is settled on by the network of participants, rather than by a central authority or government.

The operating system and associated methods described herein aim to provide a platform by way of which users (7) interact with the centralized and decentralized services (3, 5) in a frictionless manner and develop software tools that interact with the centralized and decentralized services (3, 5) in a frictionless manner.

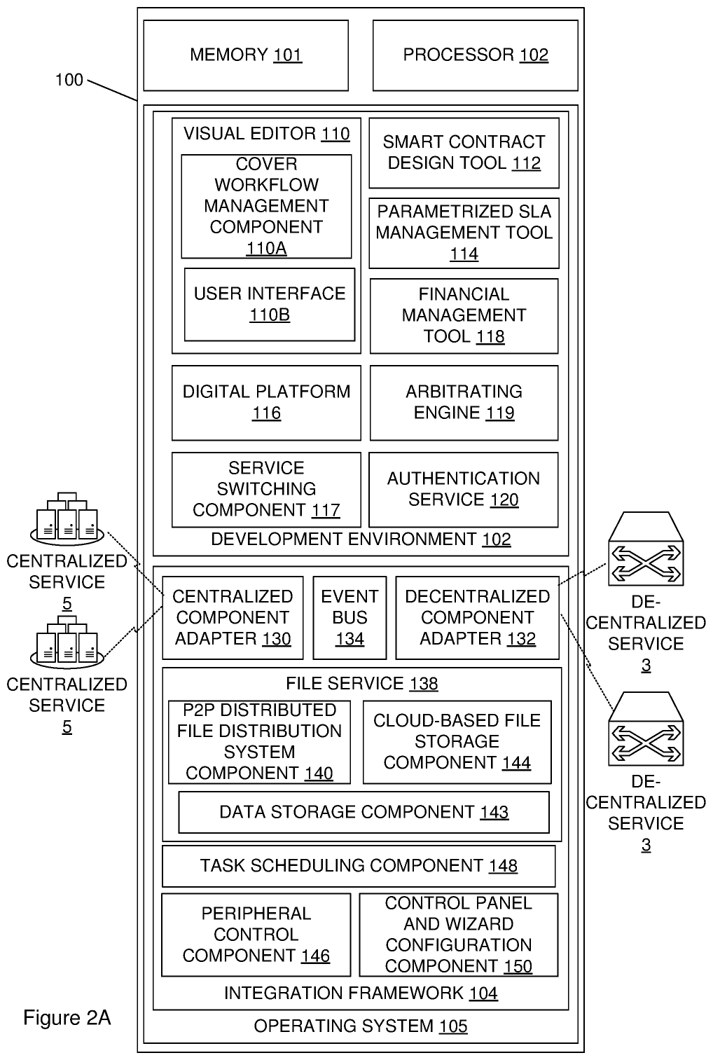

FIG. 2A is a block diagram which illustrates components of an exemplary distributed computing platform (100) having a memory (101) for storing computer-readable program code, and a processor (102) for executing the computer-readable program code. The distributed computing platform (100) facilitates the execution of an operating system (105). The operating system (105) may be arranged to support basic functionality, such as scheduling tasks, executing applications, and controlling peripherals. The operating system (105) may be a distributed operating system which is configured to run across multiple computing devices. Further, the operating system (105) may be a decentralized operating system in that some or all functions and/or processes function as decentralized elements which are loosely coupled as a collective, but without a central server controlling them. As will be described in greater detail below, the operating system (105) may provide a user interface layer for decentralized systems and applications. The operating system (105) described herein may accordingly provide a user interface toolset configured to integrate into and/or assimilate one or more decentralized services.

The operating system (105) may include a development environment (102) and an integration framework (104).

The development environment (102) may include a parametrized service level agreement (SLA) management tool (114), which is illustrated in greater detail in FIG. 2B. The parametrized SLA management tool (114) may be configured to obtain and store SLA parameters for services which interface with the operating system (105) via appropriate adapters. It warrants mentioning that, although described as part of a development environment, the SLA management tool (114) may also be provided as part of or be accessible to a monitoring environment for post-development use thereof. The SLA parameters may be extracted from the standard SLA contracts or may be determined by monitoring the service level actually provided. The SLA parameters may be stored in association with the corresponding adapter and/or service. In some cases, the SLA parameters may be verified and may be updated from time to time.

The parametrized SLA management tool (114) may include a service level parameter obtaining component (114A) arranged to obtain service level parameters for a service. The service may be provided by an external third party.

The parametrized SLA management tool (114) may include a risk quantifying component (114B) arranged to quantify risks associated with each parameter. The parametrized SLA management tool (114) and/or risk quantifying component (114B) may be configured to identify risks associated with the SLA parameters. This may include identifying risks specified in the SLA (e.g. risk associated with service downtime) as well as risks associated with, but not covered by, the SLA (e.g. risks associated with an external third party being hacked leading to losses, etc.).

The parametrized SLA management tool (114) and/or risk quantifying component (114B) may be configured to parameterize the risks associated with the SLA. This may include determining the state of the risk model as a function of independent quantities. This may include computing quantities that index a family of probability distributions. The quantities may be numerical characteristics of a statistical model associated with the risk. Parameterizing the risks associated with the SLA may include quantifying the potential losses in dealing with the third party service associated with the adaptor and/or service.

The parametrized SLA management tool (114) may be configured to generate a parametric distribution using the quantities which parameterize the risks. The parametrized SLA management tool (114) may include a parametric distribution generating component (114C) arranged to generate a parametric distribution based on the quantified risks. The parametric distribution generating component (114C) may generate the parametric distribution based on the quantified risks may include generating a statistical model usable in creating an insurance product. The statistical model may fully describe risk events and associated probabilities of the risk events occurring. The parametric distribution may be generated using parametric statistical methods and may assume that sample data comes from a population that follows a probability distribution based on a fixed set of parameters. Relying on a fixed parameter set may enable the parametric distribution to assume more about a given population than non-parametric methods do. As the normal family of distributions typically have the same shape and are parameterized by mean and standard deviation, knowing the mean and standard deviation, and that the distribution is normal, the parametrized SLA management tool (114) may be able to determine the probability of any future observation.

In some cases, the parametrized SLA management tool (114) may be configured to link the parametric distribution associated with the SLA of the adapter and/or service to an insurance product. In some implementations this may include identifying an insurable risk, quantifying the insurable risk and calculating a premium payable for insurance of the insurable risk for the amount quantified. In some implementations, the service provider (13) may act as the insurer and make use of an underwriter. In other implementations, the service provider (13) may offer systems to insurance companies who wish to offer this type of insurance to their customers (the users). For example, the parametric distribution may be posted to an online insurance market place via which third party insurance providers may be able to bid to insure the insurable risk.

The parametrized SLA management tool (114) further includes an access component (114D) for providing access to the parametric distribution to a digital platform. The digital platform may be remotely accessible to external third parties. The access to the third parties may be provided remotely through an appropriate API or through a publication/subscription (“pub/sub”) socket connection to the digital platform, for example.

The parametrized SLA management tool (114) may include a monitoring component (114E) arranged to monitor the level of service provided by the external third party. The parametrized SLA management tool (114) and/or monitoring component (114E) may be configured to monitor the service and/or adapter and evaluate the service level being provided. Monitoring the service and/or adapter may include monitoring the service and/or adapter for a breach in the service level agreement. The parametrized SLA management tool (114) and/or monitoring component (114E) may include monitors which are configured to monitor the service level being provided by the external third party service and to detect a breach should it occur.

The monitors may be configured to detect early warnings and may be arranged to log breaches in agreed service levels and generate and transmit an alert. The alerts may be transmitted to one or both of the third party providing the service, the party maintaining, operating or licensing the operating system and any other interested parties. The monitors may further be configured to identify a service level breach which indicate that a financial loss is likely to be incurred. The monitors may log such breaches and transmit alerts sent out to interested parties and optionally an insurance claim system.

While monitoring is primarily automated and performed without human intervention, in some aspects of the disclosure, third party human/system validators may be used. For example, an API may be used to purchase a container load, but the inventory may not arrive at a port within the prescribed time limit. In such a case a third party system, such as a human validator, may indicate failure on a system which is connected to, for example, the monitoring component (114E. Once an even has been logged, it could impact the reliability metrics that are parameterized around a service. The monitoring component (114E) may detect the breach through the third party system/validator and appropriate adjustments may be made.

The parametrized SLA management tool (114) may include an action component (114F) arranged to take an action if a service level parameter is breached by transmitting a notification to of a service level parameter breach to the breach to the remotely accessible digital platform. The notification may be forwarded to a selected external third party in order to trigger connection of an alternative centralized or decentralized distributed service to the client devices (in permanent or temporary replacement of the service responsible for the breach).

The parametrized SLA management tool (114) may accordingly be configured to construct parametric distributions usable to take action in reaction to and/or mitigate the risk of service level breaches. This may involve defining performance criteria and defining events (e.g. using special workflows) which are configured to handle non-performance. Costs for each service may need to be defined (and, e.g., in the case of switching from one service to another, there may be a calculated cost in making the switch). Losses in cases where a service level is breached may need to be defined which may be over and above the switching costs. Losses could be determined in, for example one or both of the following ways: a standard fee paid to the customer for every service breach (possibly moderated by a severity factor); and, the user actually providing documented proof of losses, which need to be manually verified.

When establishing an initial arrangement with the user/organization, risk tolerance may be defined. This may include defining, in case of losses, what level of deduction the user wants to have (i.e. between zero and a predetermined amount). This could be across all performance criteria or per SLA performance item. This may further include defining the importance of performance per SLA item. For example, breach of performance may be almost, in which case a higher ‘premium’ payment would be acceptable in order to ensure that switching of services would be made, even at much higher prices. In other cases, the breach may be tolerable, in which case a higher ‘premium’ payment would not be accepted, leading to a situation where switching of services would be less likely. The parametric distributions generated may have a normal (or at least symmetric) distribution; homogeneity of variances (data from multiple groups have the same variance); linearity (the data has a linear relationship); and, independence (the data are independent). The parametric distribution referred to herein may make assumptions about the parameters (defining properties) of the population distribution(s) from which the data are drawn.

The service level parameter obtaining component (114A) may include an API component (114G) arranged to create a connection to an Application Programming Interface (API) provided by the service. The API component (114G) may make API function calls to the service to induce a measurable effect on the service or to provoke a response from the service. The service level parameter obtaining component (114A) may further include an extracting component (114H) for extracting service level agreement data extracted from an agreement in which the external third party agrees to provide a level of service defined in terms of the service level parameters.

The monitoring component (114E) may observe the effect or response from an API function call to the service performed by the API component (114G). The monitoring component (114E) may observe a completion time of the response, a return value received in reaction to the API function call, or a failure rate of the API function call, to name a few exemplary observations the monitoring component may utilize for its monitoring purposes.

The integration framework (104) may include a centralized component adapter (130). The centralized component adapter (130) is configured to provide an interface between the operating system (105) and external, centralized services (5). The external centralized services (5) may be services provided by external third parties which are implemented using centralized computing technology. The external centralized services (5) may be cloud-based services (e.g. infrastructure as a service, IaaS, or software as a service, SaaS, offerings and the like). Exemplary external centralized services (5) include one or more of: accounting software (such as QuickBooks™) communication tools (such as Slack™), email services (such as Gmail™), customer relationship management software (e.g. Zendesk™), messaging gateways (e.g. Clickatell™) and the like.

The centralized component adapter (130) may be configured to provide data communication between the operating system (105) and the external centralized services (5). In some implementations, the centralized component adapter (130) may be configured to provide individual adapters for each of the external centralized services (5) with which the operating system (105) interacts. The centralized component adapter (130) may be configured to interact with application programming interfaces (APIs) provided by the external centralized services (5). The centralized component adapter (130) may provide a request/response communication layer and/or an http-based messaging layer. The centralized component adapter (130) may be configured to provide a call back service by way of which the operating system (105) can receive alerts relating to events. The centralized component adapter (130) may be configured to relay the call back to an event bus, which in turn can allow internal listeners to execute a workflow handler that will follow a predefined process.

The integration framework (104) may include a decentralized component adapter (132). The decentralized component adapter (132) is configured to provide an interface between the operating system (105) and external, decentralized services (3). The external decentralized services (3) may be services which are implemented using decentralized computing technology. The external, decentralized services (3) may be blockchain technology based services such as bitcoin, Ethereum and the like as well as peer-to-peer-based services, such as the so-called “InterPlanetary File System” (IPFS).

IPFS is a P2P-driven protocol which may be used in place of or as a supplement to the centralized http protocols. IPFS and the blockchain are well-matched as one can address large amounts of data with IPFS, and place the immutable, permanent IPFS links into a blockchain transaction. This timestamps and secures content, without having to put the data on the chain itself.

The decentralized component adapter (132) may be configured to provide data communication between the operating system (105) and the external decentralized services (3). In some implementations, the decentralized component adapter (132) may be configured to provide individual adapters for each of the external decentralized services (3) with which the operating system (105) interacts. The decentralized component adapter (132) may have access to an internal representation of the relevant P2P protocols or, in the case of blockchain technology-based external decentralized services (3), a node to that particular chain that it manages. The decentralized component adapter (132) may be configured to make changes to a blockchain file structure, which will cause a propagation of the changes to propagate through the relevant blockchain ecosystem so as to trigger a functional transaction in that system. The decentralized component adapter (132) may include one or more listening components which interact with an event bus to report any changes being made to the external decentralized service (3) with which it is interacting. The listening components may be configured to call and execute appropriate workflows upon detecting predefined events on external decentralized services (3).

The decentralized component adapter (132) may be configured to provide data communication between decentralized services in the form of decentralized applications (dApps) and the operating system (105). The decentralized component adapter (132) may be configured to assimilate the dApps into the operating system (105) such that the dApps are accessible to the users of the operating system (105) (e.g. via block available in the visual editor (110)). The dApps may have front ends which may be made up of a series of files (HTML, JavaScript, CSS, JSON, and so on) which may be stored in a centralized file system (e.g. Amazon Web Services-based) or a decentralized file system (e.g. IPFS). The files may be generated by backend apps in real-time or, in the case of decentralized file systems, immutable static files may be used.

In some cases, the decentralized component adapter (132) may provide a smart contract which is configured to connect to a blockchain or other P2P system. The operating system (105) may accordingly be configured to connect to decentralized systems and to build front-ends and various user interface mechanisms.

In some cases, the decentralized component adapter (132) may be configured to interface with oracles built into smart contracts and/or dApps. Oracles may be any suitable components of code which may be incorporated into smart contracts or dApps and which are configured to watch the blockchain for events and to respond to these events by publishing the results of a query back to the smart contract. In this way, contracts can interact with the off-chain (e.g. centralized) world.

In some cases, adapters may be developed by members of a community for a reward (e.g. a token-based reward). Adapters may be customized and available only to specific entities or generic and available for use by all entities. The adapters may provide a framework that enables data communication between the operating system (105) and third party API services (centralized) as well as blockchain or P2P services/systems (decentralized). The adapters may enable multiple pre-integrated services to communicate with standard systems, such as Ethereum Smart Contracts. The adapters may also include an associated toolkit by way of which further adapters can be built. Adapters may be used in the visual editor (110), for example by dragging and dropping workflow tasks into the visual layer, which may remove the need to code to these tasks.

The adapters may enable switching between services provided by different external third parties.

Switching may be in response to a service being down, based on economic considerations, risk considerations (e.g. based on risk determined by the parameterized SLA management tool) and the like. In some implementations, logic may be provided for recalculating contractual relationships based on switching between external third parties.

The adapters, for example the centralized component adapter (130), may make use of machine-readable interface files (e.g. OpenAPI or Swagger specification files) for describing, producing, consuming, and/or visualizing the external third party services. In some implementations, the adapters may interrogate a machine-readable interface file to automatically set up one or more workflows configured to call a corresponding API. This may enable tools to automatically build connectors to APIs of external third parties. Once set up, these automated tools may be configured to log calls to the APIs for failure and success. The tools may interact with the monitoring component (114F) so that the reliability of the APIs can be determined so as to enable the parameterized SLA management tool (114) to determine SLA standards per API that can be used in creating the parametric distributions for insurance purposes. In some implementations, the integration framework (104) includes one or more adapter building components which are arranged to interface with machine-readable interface files (e.g. OpenAPI or Swagger specification files), extract data therefrom and use the extracted data to build an adapter (such as those described in the foregoing).

In some implementations, the adapters may include one or more core elements. The core elements may be written in a suitable programming language using an actor model (e.g. Erlang or suitable equivalent). The actor model may treat “actors” as universal primitives of concurrent computation. In response to a message that the actor receives, it may perform one or more of the following operations: send a finite number of messages to other actors; spawn a finite number of new actors; change its own internal behavior, taking effect when the next incoming message is handled (e.g. make local decisions and/or determine how to respond to the next message received). Actors may modify private state, but can only affect each other through messages. The actors may be configured as Nano-servers and may be arranged to swarm together to create dynamic systems. The actors may be configured to operate without any central core or central memory or central database.

Messages are sent asynchronously and can take arbitrarily long to eventually arrive in the mailbox of the receiver. Also, the actor models make no guarantees on the ordering of messages. An actor typically processes incoming messages from its mailbox sequentially using the aforementioned possibilities to react. The possibility of changing its own internal behaviour, eventually allows the actor to deal with mutable state. However, the new behaviour is only applied after the current message has been handled. Thus, every message handling run may still represent a side-effect free operation from a conceptual perspective.

The techniques employed in actor models to manage so-called ‘side-effects’ may be employed to communicate with external third party services. The adapters described herein may accordingly use the actor model to communicate with the external third party services.

The integration framework (104) may include a provisioning component which is arranged to provision adapters, workflows and the like.

The integration framework (104) may include an event bus (134). The event bus (134) may be configured to provide a communication channel for use by components of the operating system (105). The event bus (134) may enable interoperable communication between components without those components being specifically configured to communicate with each other. Components of the operating system (105) may be configured to connect to the event bus (134) and listen for specific information or detect the occurrence of predetermined events. This functionality may be provided by subscribing to an event. Other components may place event on the bus as they occur which will in turn be detected by the component subscribing to that event.

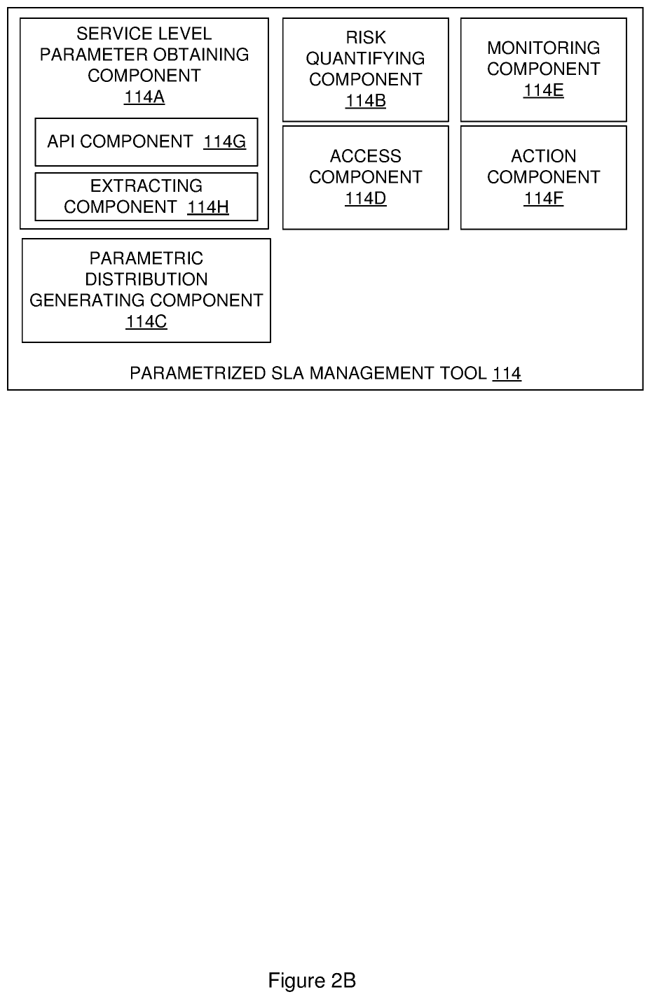

The parametrized SLA management tool (114), centralized/decentralized component adapters (130, 132), event bus (134) described above (and each of its respective components) may be arranged to provide the functionality and/or perform the operations of the method described below with reference to FIG. 3. Further components of the operating system (105) will be described in greater detail below.

FIG. 3 is a flow diagram which illustrates an exemplary method (200) for service level risk management. The method may be a computer-implemented method and may execute on an operating system, such as that described above with reference to FIGS. 2A and 2B, which includes a centralized component adapter for interfacing with centralized services and a decentralized component adapter for interfacing with decentralized services. In some implementations, the method may be performed by components of the parameterized SLA management tool (114) described further below.

The method may include obtaining (202) service level parameters for a service provided by an external third party. The service may be a centralized service or a decentralized service, as described in the foregoing. Obtaining (202) service level parameters for the service may include extracting actual service level agreement data from a contract in which the external third party agrees to provide a level of service defined in terms of the service level parameters. Obtaining (202) service level parameters may further include estimating parameters of an expected service level based on historical observations.

Furthermore, obtaining (202) service level parameters for the service may include establishing a connection to an Application Programming Interface (API) provided by the service and calling an API function associated provided by the particular API. The service level parameters may be determined by evaluating the reaction or effect that results from the API function call. The result may, for example, be one or more return values received from the API function call. An API to request information from a third party service elicits a response (which could be an immediate, synchronous response, or a delayed asynchronous response) that contains data in an expected format, based on the initial query parameters.

Some services may formally encode the service level agreement of their API functions in a predetermined format, such as a predefined JSON data structure (which could be logged for future reference). These return values may also be evaluated from the completion time of the particular API function call, which may be associated with a particular service level parameter. It may further be determined by a failure rate of the function call, for example.

Regardless of the manner in which a particular service level parameter is obtained, the obtained parameter may be logged along with data that may have been used to obtain it. For example, when the service level parameters are obtained using an API function call method, the data sent as part of the function call and the return values may be logged; or the completion time of each API function call. Based on this logged historical data, it may therefore be possible to build up a profile of each service from an aggregate of all the responses. The API response information may be stored in a log or database as it is received; or it may be transformed first into a desired structure before logging that data in the log or database.

In some cases the purpose of making a request to the third party service is not to, primarily, request information, but rather, to create an effect on that third party service. So, for example, a request may be made to a third party service to send an SMS to a designated recipient. In this case some form of synchronous and/or asynchronous response may be expected to indicate if the SMS was sent successfully (or not) and maybe other forms of metadata, including, for example, how long it took to send the SMS. This response data may be collected as a form of obtaining (202) service level parameters.

In making a request to a third party service, a maximum amount of time may be prescribed for the response to be received before either retrying a specific number of times or considering the request to have failed.

Each API of a third party service may publish its set of API calling functions, so that the consumer of the API (in this case, the parametrized SLA management tool (114)) can develop a set of requesting functions. These published API service calls may: be published on a website with instructions and examples; use a standardized protocol of publishing API specifications, such as the OpenAPI 3.0 protocol, where API specifications can be written in YAML or JSON and the format is easy to learn and readable to both humans and machines. Within an API system, the formal request protocol has a defined series of parameters that will be included in the request. The response will also have a defined list of expected parameters.

Furthermore, the API definition may also, in many cases, define the number of retries or timeout rules. In other cases, the developer who writes code to make the request may have to explicitly build their own rules around retrying or timeouts.

In some cases, providers of APIs may formally encode the service level agreement of their API functions in some format, such as JSON, XML, or other formats. In these cases, there would be a way to formally log the SLA guarantees of the API provider. In other cases, the provider of service may describe their Service Levels in a formal legal document on their website; and in other cases there may be a formally negotiated hard copy contract concluded with the customer, in which terms of the SLA are provided. In other cases there may be no specific SLA for one or more functional systems, but the SLA may be implied by law or custom.

Whether there are SLA guarantees or not, the parametrized SLA management tool (114) may be aware of all of the parameters that are expected back from a provider each time they request information or each time they request ‘an effect’ on the third party system.

Each response from the third party system may be logged in a logging system and/or database. Every single ‘event’ may be used as an opportunity to store the parameterized response. Based on this, it is possible then to build up a profile of each service where all the responses are aggregated as well as storing every single instance of a response. For example, a high level metric that could be recorded or calculated is, of all the responses, how many of them are considered successful or failed. If this number was 95% success, then that may be compared to the SLA guarantee, or to industry standards.

The method may include quantifying (204) risks associated with each parameter. Quantifying (204) risks associated with each parameter may include determining consequences associated with the service level parameters. Quantifying risks may include, for example, assigning a system performance loss associated with service level parameters or assigning a financial loss associated with service level parameters. This may include a financial loss which may be incurred in compensating for failures, delays, etc. anticipated in the service level parameters. Quantifying risks associated with each parameter may use a machine learning algorithm to dynamically estimate and update consequences associated with the service level parameters.

Each event, with all its parameters may be stored in a permanent log, database or in-memory storage system. Risks may be quantified initially, based on a provided SLA agreement, as well as the continual stream of historical information that may be similar or different to the risks that were set up as the initial risk assessment.

While the historical information and various statistical methods may be used to deduce the risk profile, an alternative method may be to build a machine learning model that is built by evaluating a stream of data from this specific API function, additionally combined with other relevant data system inputs. This machine learning model can then be used to evaluate risks by taking some simple input parameters and indicating a risk

The method may include generating (206) a parametric distribution based on the quantified risks. Generating (206) the parametric distribution based on the quantified risks may include generating a statistical model. The statistical model may fully describe risk events and associated probabilities of the risk events occurring. One exemplary use of such a generated statistical model, is its use in creating an insurance product.

The system may connect to a multiplicity of third party services and may maintain: a list of every third party service; a list of every functional request to each of those third party services; a list of every parameter that needs to be sent to that service as an input to that service; a list of every parameter that needs to be returned from that service per request; a historical log of every previous request to that service; and a function to construct and provide the parametric distribution of the service.

The method includes providing (208) access to the parametric distribution to a digital platform that is remotely accessible to external third parties.

The method may include monitoring (210) the level of service provided by the external third party. Monitoring the level of service may include continually, periodically or intermittently monitoring the level of service via the centralized component adapter (130) or decentralized component adapter (132), as the case may be. Monitoring (210) the level of service may include, for example, monitoring one or both of service uptime and service lead time. Monitoring service uptime may include determining one or more of: occasional downtime of the service; a length associated with the downtime; and, the total downtime per period. Monitoring service lead time may include executing a machine learning algorithm configured to observe delivery patterns associated with the service and to determine an expected service lead time based on the observed delivery patterns. Monitoring the level of service may include monitoring the level of service for a breach, an anticipated or predicted breach or the like. In some implementations, monitoring the level of service may include monitoring methods or functions (e.g. of a workflow) that need to be performed so as to determine a service level associated with performance of the methods or functions. This service level may be considered a contract in respect of the performance of the methods or functions. In some implementations, additional workflows may be created based on failure of a function or method which may be associated with costs and/or losses.

Data relating to the monitored level of service for use and in estimating the parameters of the expected service level may be logged or otherwise stored.

The method further includes detecting (212) a breach in a service level parameter. The detection (212) and resulting action taken may occur in anticipation of a breach or predicted breach. A monitoring tool for log data, such as Logstash, may be used which includes a system that can detect when an SLA condition is breached, or detect a critical situation where the system is close to being breached. Actions taken may include such actions as informing key personnel to remediate, sending information to interested and/or affected so that they may take remedial action. Notification may occur by a number of means, including pub/sub socket connections or API function calls for machine-to-machine notifications for example; or by means of SMS, email, phone, or fax to notify key personnel.

The method further includes transmitting (214), in response to detecting (212) a breach in a service level parameter, a notification of the breach to the remotely accessible digital platform for on forwarding to a selected external third party. The notification may trigger the connection of an alternative centralized or decentralized distributed service to the client devices. This may, at least to some extent, mitigate the quantified risk associated with the breach of the relevant service level parameter.

One exemplary application that may utilize this method is the dynamic creation of an insurance product in respect of the quantified risks including determining a quantum and a premium payable in return for the insurance product. The insurance product may be activated dynamically (e.g. in real time and without human intervention) so that risks associated with service level parameters are mitigated automatically. In other implementations, the method may include making the parametric distribution accessible to a digital insurance market place on which external insurance providers dynamically bid to provide an insurance product in respect of the quantified risks. The method may include dynamically updating the insurance product in response to changes detected in the data relating to the monitored level of service.

The demand placed on the various services and the distributed computing platform may change unexpectedly and rapidly due to the nature of the technology, i.e. computer technology, which by its very nature executes at speeds far exceeding that of humans. As a result of these fluctuations, the service levels may similarly fluctuate and, in turn, the risks associated with the relevant service level parameters. Dynamically updating the insurance product may therefore include updating the insurance product in real-time and without human intervention. This may result in a constantly updated insurance product which adapts as risks associated with the service level change.

In such an exemplary application, the method may include taking an action if a service level parameter breach is detected (210). In some cases, an action may be taken in anticipation of a breach or predicted breach. The digital platform may be notified (212) of the breach which, in turn, may forward the notification to the insurer service (as an external third party). This may trigger the external third party, in this exemplary application the insurer service, to locate another external third party providing the same service and switching to that service. This may be performed dynamically and without human intervention and may be configured to mitigate any risks associated with the service level breach. In some implementations, such action may be taken if the service goes down, regardless of whether or not that downtime constitutes a service level breach.

In such an exemplary application, the parametrized SLA management tool (114) may be configured to calculate and/or adjust the insurance premium dynamically in real-time. The parametrized SLA management tool (114) may be configured to determine time-based, periodic-based and/or transaction based insurance premiums. This may include regenerating the parametric distribution.

It is anticipated that in some implementations, the external third party services may be rated. Ratings may be provided by users (7), the service provider (13) or, in some cases, a trusted third party, such as an auditor. Rating may be informal, e.g. a one to five star rating, or through a formalized intervention where a rating agency or trusted party evaluates the service of an external third party. In some implementations, trusted third parties may make use of registries (such as those provided by Civic Technologies, Inc.) to profile such services. Aspects of the disclosure may rely on such informal and formal rating systems to add to the parameters of each service and affect the insurability and insurance costs of using such services.

Aspects of this disclosure, for example the adapters (e.g. the centralized component adapter (130), visual editor (110) and parameterized SLA management tool (114)), may enable automatic building of connectors to APIs and observing their reliability to build a parameterized SLA descriptor.

Aspects of this disclosure may combine SLA management, switching, insurance, automatic provisioning, codeless programming, etc. so as to enable a systems developer to add complex systems to code almost automatically. Aspects of this disclosure may be directed towards frictionless adapters which may allow organizations to: operate with fewer software engineers; and, complete projects more cheaply, faster and with inbuilt governance and risk management. In some cases, simple instructions may be received from users from which rules and/or machine learning models may be used to automatically compose backend services. In some cases a conversational input, such as speech or text in the form of a chatbot (e.g. where the process is initiated by first using natural language processing) may be used to receive the user input. The rules and/or machine-learning model-based composition of adapters and underlying services may then be executed based on the received input.

Referring again to FIG. 2A, further components of the operating system (105) are described below.

The development environment (102) may include a visual editor (110). The visual editor (110) may include a set of user interfaces for designing, executing and monitoring workflows. The visual editor (110) may be connected to external third party and/or internal services and may present capabilities of these services as blocks. The visual editor (110) may include a cover workflow management component (110A). The blocks can be connected to each other to form chains of execution, which are presented as workflow diagrams. Workflows are triggered by specific events, which may be specified at the start of the workflow and can be generated by any (centralized or decentralized) service.

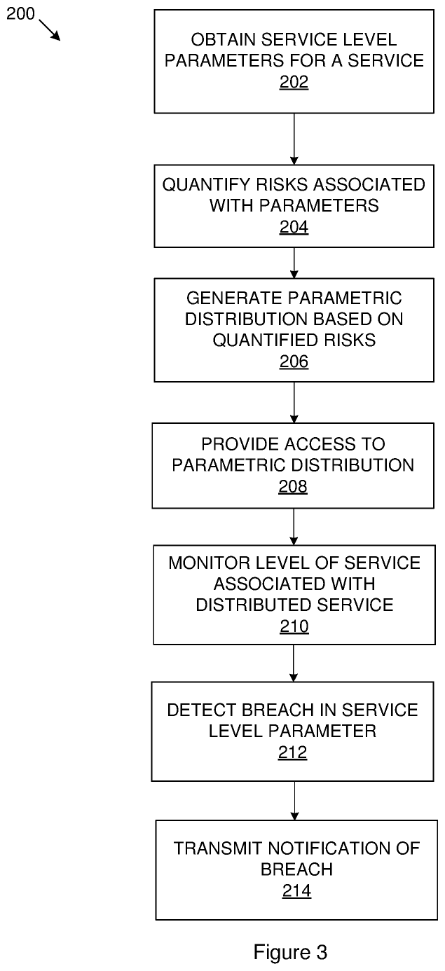

The visual editor (110) may include a user interface (110B). The user interface (110B) may provide a set of user interfaces arranged for designing, executing and monitoring workflows. FIG. 4 is a schematic diagram which illustrates an example user interface (400) of the visual editor (110). The example user interface (400) includes a workflow canvas (402) which defines the area where workflows are drawn by users and displayed. The canvas (402) may be scrollable so that large workflows can be edited on the same screen. The example user interface (400) may include a block palette (404) in which various workflow blocks are provided and from where blocks (406) can be selected and dragged onto the canvas (402). The example user interface (400) may include a block editor (408) in which settings pertaining to a selected block can be viewed and edited. The block editor (408) may for example be used to configure a block's inputs, outputs, etc.

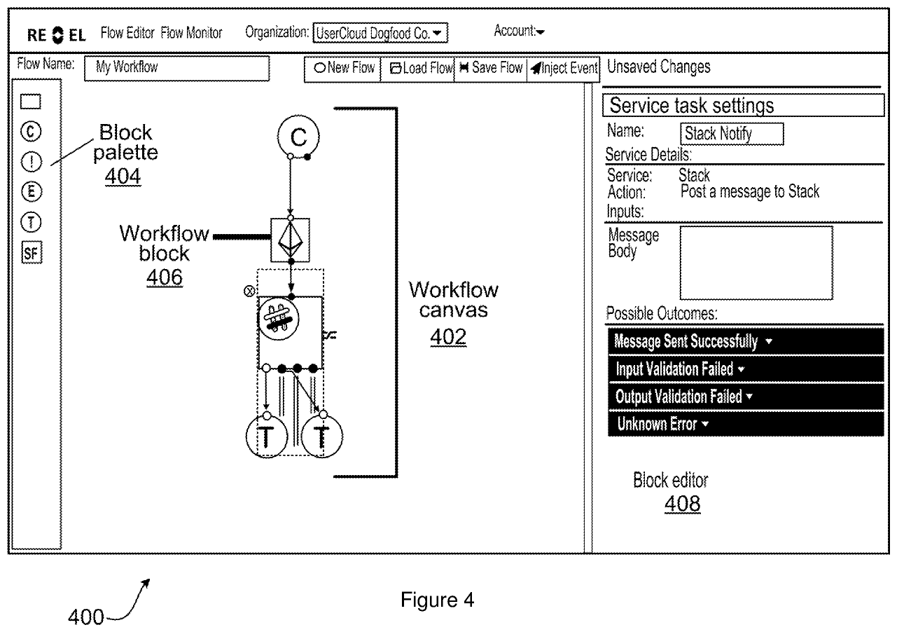

The visual editor (110) may be configured to support free-form positioning of blocks, i.e. the blocks can be positioned anywhere on the canvas (402) and may not be configured to snap to a grid (see e.g. FIG. 5).

The visual editor (110) may be configured to perform design-time validation of data. The visual editor (110) may be configured to define inputs and outputs for tasks with complex structures as opposed to flat key-value pairs. The visual editor (110) may be configured to provide task inputs and/or outputs in the form of a nested structure (e.g. defined as JSON or a suitable alternative). This may allow the context of data to be preserved (e.g. a postal address contains a box number and a postal code). The visual editor (110) may be configured to compare the structures of connected blocks and determine and propose entire portions of data that could match. This may reduce the burden on the user from having to map each and every field manually, as the visual editor (110) can infer potential matches by identifying similarities in the JSON structure.

The visual editor (110) may be configured to provide data items which include their own validation rules. Each piece of data may have an associated validation rule which may be a part of the JSON structure (e.g. a particular character string must be a valid e-mail address, a particular number must be a valid percentage between 0 and 100, etc.). These rules may be defined on a block's inputs and outputs and the visual editor (110) may be configured to alert the user when he or she tries to connect blocks where the output and input have conflicting validation rules.

The visual editor (110) may be configured to support multiple output ports per block. In some implementations, a block may provide various possible outcomes depending on the result from the underlying service. For example, when sending an e-mail, it might fail for various reasons such as the recipient being unavailable and the block may be configured to take a different path in the workflow depending on a block's outcome. Defining different behaviours for each outcome may include inspecting an output field of the block and responding to that value.

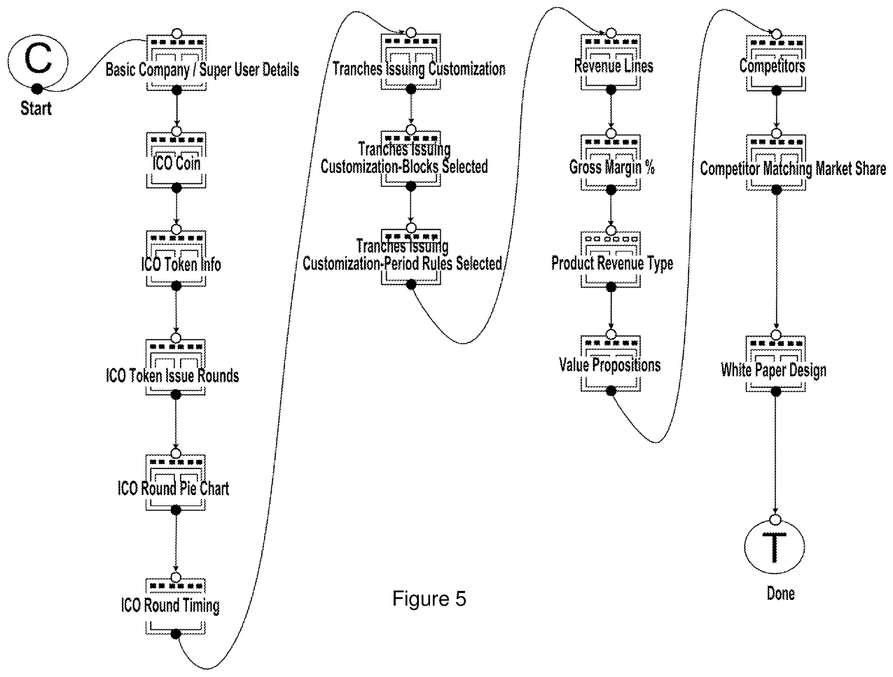

The visual editor (110) may be configured to display a block's potential outcomes as a separate output connection point. Lines can be connected to each output connection point separately, so that any branching behaviours are apparent by looking at the diagram. The user can follow the lines on screen and see what would happen for every possible outcome of a block, without having to open a configuration panel. The visual editor (110) may be configured to hide unused output ports to reduce clutter. FIG. 6 illustrates an exemplary block which includes a task defining six output ports (412), two of which are connected to downstream blocks (414, 416) such that different outcomes (e.g. ‘success’ and ‘input_validation_failed’) are connected to different blocks.

The visual editor (110) may be configured to permit each outcome to define its own data structure. A block's output data may be different depending on its outcome. A successful outcome may provide a different set of results than a failure outcome. The visual editor (110) may be configured to determine which outcome's dataset should be used when performing validation. For example: Task A may define two outcomes (‘success’ and ‘failure’). If task B is connected to the ‘success’ outcome and task C is connected to the ‘failure’ outcome, the visual editor may permit task B to access only the ‘success’ output fields and not the ‘failure’ ones, since it can detect which of task A's output ports is linked to task B. It can do this even if there are other blocks between task A and task B.

The visual editor (110) may be configured to enable arbitrarily nestable workflows. A workflow can be packaged into a block called a subflow block, which can then form part of a larger workflow. The visual editor (110) may be configured to allow for multiple levels of nesting. The user may be able define various outcomes for a workflow, along with data structures for each outcome. These outcomes then become the output ports of the subflow block. The output ports can be used just as with any other block. This allows workflow designers to work at various levels of abstraction. One designer may work on low-level workflows interfacing with external third party services. These workflows can then be packaged into the block library for other designers to use. For example, a low-level designer may build a flow that chooses a particular SMS gateway based on changing costs. This flow could be packaged as a ‘Send SMS’ block that other designers can use in their workflows without having to know which gateway was chosen by the lower level workflow.

The visual editor (110) may be configured to provide a visual flow monitor and debugger. The visual editor (110) may provide functionality which allows the user to inspect workflows as they are running. As each block runs, it is highlighted and its input and output data are displayed. The user can also interact with the flow by setting breakpoints, pausing execution and changing input/output values before resuming. This enables more complex workflows to be built as the debugger may make finding errors simpler.

The development environment (102) may include a smart contract design tool (112). The smart contract design tool (112) may be configured to create and maintain smart contracts. The term “smart contract” may refer to any suitable computer protocol intended to facilitate, verify, or enforce the negotiation or performance of a set of rules (e.g. as may be encapsulated in a contract). Smart contracts may be any suitable account holding objects and may be stored on a suitable blockchain. They may contain code functions and can interact with other contracts, make decisions, store data, and send cryptocoins to others. Smart contracts may be defined by their creators, but their execution, and by extension the services they offer, may be provided by the relevant blockchain network itself. They will exist and be executable as long as the whole network exists, and in some cases will only disappear if they have been programmed to do so.

The smart contract design tool (112) may be configured to provide, together with the financial management tool (118), functionality for the minting and/or issuing of new forms of cryptocoins. The smart contract design tool (112) may also be configured to facilitate connection to smart contract exchanges, define standard smart contracts, write new smart contracts, create high level smart contracts that communicate with lower level smart contracts, and the like. The smart contract design tool (112) may also be configured to facilitate communications with smart contracts for the purposes of injecting information and/or data into smart contracts and/or extracting information and/or data from smart contracts.

The development environment (102) includes a digital platform (116) which, in some implementations may include an insurance marketplace interface. In such implementations, the insurance marketplace interface may be configured to interface with an external digitized insurance marketplace by way of which third party insurance providers can bid on insurable risks posted by operating systems of a number of users. The external digitized insurance marketplace may be configured to enable insurance providers to bid on insurable risks by proposing insurance premiums for the quantified insurance amount. The insurance marketplace interface may be configured to post insurable risks and associated quantified insurance amounts to the marketplace for bidding on by external third parties, to receive bids from external third parties, to present the bids for acceptance or rejection by the operating system (e.g. in accordance with rules defined in a smart contract) or a user of the operating system and to communicate the acceptance or rejection of the bid, as the case may be, to the external third party via the marketplace.

The development environment (102) may include a financial management tool (118). The financial management tool (118) may be arranged to facilitate the minting of an organization-specific cryptocoin. The cryptocoin may be configured for use by the organization making use of (e.g. licensing) the operating system to pay for third party services. In some cases, the organization may use its cryptocoin to pay the entity providing the operating system (e.g. the entity having developed and selling the operating system as a service) who in turn may make payments to the entities providing the external third party services to which the operating system connects and/or with which the operating system interacts. In some cases, financial management tool (118) may be configured to facilitate the minting of a cryptocoin for use in an initial coin offering. The financial management tool (118) may further be configured to manage a number of other currencies and cryptocurrencies. The financial management tool (118) may be configured to define and operate non-crypto currencies, create taps (a mechanism for earning money), sinks (a mechanism for spending money) and levers (a mechanism for converting money) within the organization and design flows within a visual economy editor. The financial management tool (118) may be configured to define currency connectors and rules to manage payments. The financial management tool (118) may be configured to interface with any number of decentralized coin operated services and handle the exchange of money, including currency conversions. The financial management tool (118) may be configured to create and manage an organizational economy.

The development environment (102) may include an authentication service (120). The authentication service (120) may be configured to maintain user accounts and permissions and authentications associated with those user accounts. The authentication service may provide a service by way of which a user is able to authenticate him or herself with the authentication service. In response to successful authentication with the authentications service, the authentication service may be configured to authenticate the user with the services which the user is permitted to access. An indication of the services which the user is permitted to access may be stored in a permissions list associated with the user account. The authentication service (120) may further permit selected users to configure the permissions lists of other users. The authentication service (120) may accordingly provide a central point though which multiple users of the operating system may be authenticated and permitted to access associated services. The authentication service (120) may facilitate the access and authentication of every user to every service within the operating system (105).

The event bus (134) may interface with the visual editor (110) for the representation of events as visual blocks on workflows. This may enable a visual workflow to listen for an event on the event bus (134). By using the visual editor (110), users may be able to leverage the same event model as the developers coding the backend systems.

The event bus (134) may further include a portal by way of which client applications (e.g. web sites, smartphone applications, etc.) can also subscribe to specific backend events. The event bus (134) may be configured to handle the transmission of these events over the network using web sockets. The client does not have to know where the event originated. The event bus (134) may enable flexibility where various types of developers (backend, front-end and workflow developers) can tap into the same set of events to build new applications.

The integration framework (104) may include a file service (138). The file service (138) may include a peer-to-peer (P2P) distributed file distribution system component (140) arranged to interface with a nodes in a P2P distributed file system, such as IPFS. The P2P distributed file distribution system component (140) may be arranged to enable access to the P2P distributed file system, for example via the so-called filesystem in userspace (FUSE) software interface, hypertext transfer protocol (http) and the like. The P2P distributed file distribution system component (140) may be configured to add a local file to the P2P distributed filesystem, making it available to all other nodes on the P2P network. Files may be identified by their hashes and may be distributed using a P2P communication protocol (e.g. BitTorrent). Other users viewing the content aid in serving the content to others on the network. The file service (138) may include a cloud-based file storage component (144) arranged to provide access to cloud-based file storage (e.g. Amazon's Elastic File System). The file service (138) includes a data storage component (143) for logging of any API function calls made by the API component (114G), data included in such API function calls, and data returned from an API function call. The data storage (143) may utilize the functions of the (P2P) distributed file distribution system component (140) and the cloud-based file storage component (144) for such logging purposes.

The integration framework (104) may include a peripheral control component (146). The peripheral control component (146) may be configured to control peripheral devices, such as printers, displays, speakers, microphones, virtual reality headsets etc. The peripheral devices may be cloud-based devices (e.g. network connected) and may include Internet-of-Things (IoT) devices. The peripheral control component (146) may be configured to interface with third party cloud device drivers and IoT devices. The devices may be configured and setup by way of a control panel.

The integration framework (104) may include a task scheduling component (148). The task scheduling component (148) may be configured to schedule the launch of services (including applications, programs, scripts, etc.) at predefined times, or after specified time intervals. The task scheduling component (148) may be configured to interact with a core workflow management component that is arranged to create tasks and flows across the operating system (105) and which can be triggered by the task scheduling component (148). The task scheduling component (148) may also be configured to call tasks or flows upon the occurrence of predetermined events, or when executed by other tasks or services.

The integration framework (104) may include may include a control panel and wizard configuration component (150). The control panel and wizard configuration component (150) may be configured to create, update and/or configure control panels and/or wizards. The control panel configuration component (150) may be configured to implement control panels using reusable components (e.g. software code written in HTML, JavaScript, CSS, etc.) and/or other content-based elements. The control panel and wizard configuration component (150) may be configured to arrange control panels and/or wizards using a treelike structure (e.g. using JSON). The control panel and wizard configuration component (150) may be configured to generate control panels and/or wizards with minimal scripting or coding.

By providing the control panel and wizard configuration component (150), the addition of new control panel and wizards to the operating system may be simplified. The control panel and wizard configuration component (150) may be configured to use file-based encoding of the control panels and wizards such that they can be stored in a decentralized file service, such as IPFS.

The operating system (105) may be configured to run software applications. The software applications (which may be in the form of services) may be distributed using cloud-based, P2P or blockchain-based technology. The software applications, which may provide access to the services being provided by the external third parties, may not execute locally on the computing device (11) being used by the user (7), but may instead execute in a distributed manner on a number of computing devices connected via the communication network (9). As mentioned, the software applications and associated services may be provided by external third parties or by the service provider (13).

The operating system (105) may manage a many-to-many relationship between users and services across an organization with which the users are associated. The organization may be able to authorize multiple applications and services (e.g. by configured the authentication service appropriately). Through the authentication service, different users may have access to different applications/services. In some cases, each service may have multiple roles attached to it and each role may have a differing scope. Users may have access to specific services but with differing roles and differing rights as compared to other users having access to the same service. The operating system may provide an application/service control panel in which users with special rights can install and/or approve new applications and/or services into the organizational ecosystem; users can create, vary, or remove the access control, roles and rights of all users across all applications/services; users can set up their application/service properties; users can view high level instrumentation relating to their application/service. Users can access the control panel via: a web browser; a control panel native application that could be on any third party operating system; or, any other user interface means, such as voice commands, text bots, virtual or augmented reality systems and so on.

Aspects described herein may be configured to create successive abstractions of lower level tasks by higher level tasks. Each task can define the access and scope rules of users that have access to build or use the flows. While it is envisioned that engineering type skills may be required to create low-level workflows, less technical expertise will be needed by higher-level workflows.

The visual editor described herein may be configured to enable building workflows with minimal coding. Users can create peripheral scripts that can be attached to flows. Aspects described herein facilitate integration into complex third party systems and services and to simplify the role of users within an organization (e.g. by reducing the amount of repetitive work, regain simplicity and context with their work, and be able to bring their creative force to their work). Aspects described herein may enable the use of complex third party services so as to obviate needing to replicate these. This may enable evolution of the operating system and related components as more and more third party services may be assimilated. Aspects described herein may use smart contracts to automate key elements of an organization so that users do not interfere with the flow of transactional processes. This may lead to reduced human interaction within such an environment by simplifying the role of users and providing a clearer, narrower context. This allows the users to focus on the creative work, while the technology does the automated and repetitive work. To facilitate this, aspects described herein may provide a control panel that allows each user to manage functions such as: executing applications and services, controlling peripherals, and scheduling tasks.

Aspects described herein may provide a systemic reality in the form of a business ecosystem in which humans interact with a form of a reality realm. This may incorporate aspects from augmented reality and virtual reality in order to provide a reality state of things as they actually exist and to interact with artificial intelligence to create meaning to maintain the holistic reality state.

The operating system described herein may be configured to connect to a multitude of blockchains, via the decentralized component adapter, and create a flow management between them. The operating system may implement a flow system which runs on decentralized rails in order to connect multiple blockchains to each other. Further, flows may be irrevocable and capable of inspection by interested third parties.

The operating system and associated components described herein may be configured to enable abstraction of the use of services provided by external third parties behind workflow. For example, there could be a task called: “Send SMS to this Cell Phone number”. In the Service task the customer could set its SLA requirement, e.g. Send within 1 minute, 1 hour, 1 day. The operating system described herein may have connections to multiple SMS providers (e.g. via an appropriate adapter) and based on the SLA could moderate the price to the user, while making an arbitrage.

The operating system may accordingly include an arbitrage engine (119) which is configured to evaluate what the user is trying to achieve (e.g. send 50 SMSs), determine the user's SLA requirements (delivery of SMS within 60 minutes) and identify the service which best meets these requirements and the most competitive price. Other factors, such as a user rating per provider may also be considered. The arbitrage engine (119) may accordingly be configured to dynamically consider the cost of using a particular service; risk insurance costs associated with the particular service; and a desired margin or profit for the transaction which the service provider wishes to make. The arbitrage engine (119) may also be configured to dynamically monitor competing prices to ensure the margin is competitive. The arbitrage engine (119) may include machine learning logic configured to autonomously identify arbitrages and competitive prices.

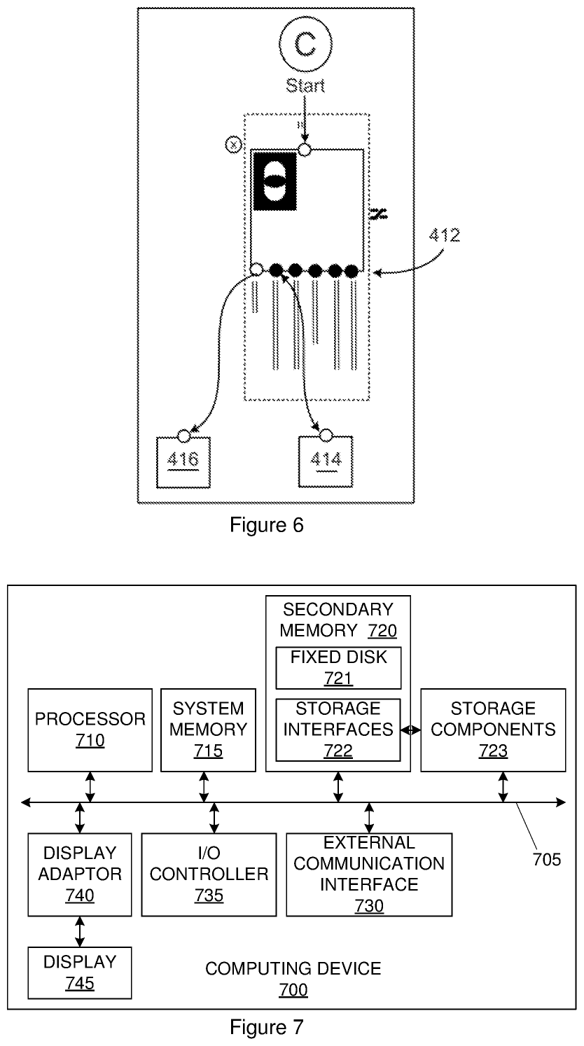

FIG. 7 illustrates an example of a computing device (700) in which various aspects of the disclosure may be implemented. The computing device (700) may be embodied as any form of data processing device including a personal computing device (e.g. laptop or desktop computer), a server computer (which may be self-contained, physically distributed over a number of locations), a client computer, or a communication device, such as a mobile phone (e.g. cellular telephone), satellite phone, tablet computer, personal digital assistant or the like. Different embodiments of the computing device may dictate the inclusion or exclusion of various components or subsystems described below.

The computing device (700) may be suitable for storing and executing computer program code. The various participants and elements in the previously described system diagrams may use any suitable number of subsystems or components of the computing device (700) to facilitate the functions described herein. The computing device (700) may include subsystems or components interconnected via a communication infrastructure (705) (for example, a communications bus, a network, etc.). The computing device (700) may include one or more processors (710) and at least one memory component in the form of computer-readable media. The one or more processors (710) may include one or more of: CPUs, graphical processing units (GPUs), microprocessors, field programmable gate arrays (FPGAs), application specific integrated circuits (ASICs), edge processors and the like. In some configurations, a number of processors may be provided and may be arranged to carry out calculations simultaneously. In some implementations various subsystems or components of the computing device (700) may be distributed over a number of physical locations (e.g. in a distributed, cluster or cloud-based computing configuration) and appropriate software units may be arranged to manage and/or process data on behalf of remote devices.

The memory components may include system memory (715), which may include read only memory (ROM) and random access memory (RAM). A basic input/output system (BIOS) may be stored in ROM. System software may be stored in the system memory (715) including operating system software. The memory components may also include secondary memory (720). The secondary memory (720) may include a fixed disk (721), such as a hard disk drive, and, optionally, one or more storage interfaces (722) for interfacing with storage components (723), such as removable storage components (e.g. magnetic tape, optical disk, flash memory drive, external hard drive, removable memory chip, etc.), network attached storage components (e.g. NAS drives), remote storage components (e.g. cloud-based storage) or the like.

The computing device (700) may include an external communications interface (730) for operation of the computing device (700) in a networked environment enabling transfer of data between multiple computing devices (700) and/or the Internet. Data transferred via the external communications interface (730) may be in the form of signals, which may be electronic, electromagnetic, optical, radio, or other types of signal. The external communications interface (730) may enable communication of data between the computing device (700) and other computing devices including servers and external storage facilities. Web services may be accessible by and/or from the computing device (700) via the communications interface (730).

The external communications interface (730) may be configured for connection to wireless communication channels (e.g., a cellular telephone network, wireless local area network (e.g. using Wi-Fi™), satellite-phone network, Satellite Internet Network, etc.) and may include an associated wireless transfer element, such as an antenna and associated circuity.

The computer-readable media in the form of the various memory components may provide storage of computer-executable instructions, data structures, program modules, software units and other data. A computer program product may be provided by a computer-readable medium having stored computer-readable program code executable by the central processor (710). A computer program product may be provided by a non-transient computer-readable medium, or may be provided via a signal or other transient means via the communications interface (730).

Interconnection via the communication infrastructure (705) allows the one or more processors (710) to communicate with each subsystem or component and to control the execution of instructions from the memory components, as well as the exchange of information between subsystems or components. Peripherals (such as printers, scanners, cameras, or the like) and input/output (I/O) devices (such as a mouse, touchpad, keyboard, microphone, touch-sensitive display, input buttons, speakers and the like) may couple to or be integrally formed with the computing device (700) either directly or via an I/O controller (735). One or more displays (745) (which may be touch-sensitive displays) may be coupled to or integrally formed with the computing device (700) via a display (745) or video adapter (740).

The foregoing description has been presented for the purpose of illustration; it is not intended to be exhaustive or to limit the invention to the precise forms disclosed. Persons skilled in the relevant art can appreciate that many modifications and variations are possible in light of the above disclosure.

Any of the steps, operations, components or processes described herein may be performed or implemented with one or more hardware or software units, alone or in combination with other devices. In one embodiment, a software unit is implemented with a computer program product comprising a non-transient computer-readable medium containing computer program code, which can be executed by a processor for performing any or all of the steps, operations, or processes described. Software units or functions described in this application may be implemented as computer program code using any suitable computer language such as, for example, Java™, C++, or Perl™ using, for example, conventional or object-oriented techniques. The computer program code may be stored as a series of instructions, or commands on a non-transitory computer-readable medium, such as a random access memory (RAM), a read-only memory (ROM), a magnetic medium such as a hard-drive, or an optical medium such as a CD-ROM. Any such computer-readable medium may also reside on or within a single computational apparatus, and may be present on or within different computational apparatuses within a system or network.

Flowchart illustrations and block diagrams of methods, systems, and computer program products according to embodiments are used herein. Each block of the flowchart illustrations and/or block diagrams, and combinations of blocks in the flowchart illustrations and/or block diagrams, may provide functions which may be implemented by computer readable program instructions. In some alternative implementations, the functions identified by the blocks may take place in a different order to that shown in the flowchart illustrations.

The language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

Finally, throughout the specification and claims unless the contents requires otherwise the word ‘comprise’ or variations such as ‘comprises’ or ‘comprising’ will be understood to imply the inclusion of a stated integer or group of integers but not the exclusion of any other integer or group of integers.

1. A computer-implemented method conducted by an operating system executing on a distributed computing platform including a processor and a memory, wherein the distributed computing platform is accessible to client devices of an organization via a communication network and wherein the distributed computing platform facilitates access to a centralized or decentralized distributed service by the client devices, the service being provided by an external third party, the method comprising:
obtaining service level parameters for the service, including estimating parameters of an expected service level based on historical data stored in the memory;
quantifying risks associated with each parameter and generating a parametric distribution based on the quantified risks;
providing access to the parametric distribution to a digital platform, the digital platform being accessible to external third parties;
monitoring the level of service associated with the distributed service via a centralized or decentralized component adapter; and,
in response to detecting that a service level parameter is breached, transmitting a notification of the breach to the digital platform for on forwarding to a selected external third party, the notification being configured to trigger connection of an alternative centralized or decentralized distributed service to the client devices.

2. The method as claimed in claim 1, wherein the step of obtaining service level parameters for the service includes establishing a connection to an Application Programming Interface (API) provided by the service, calling an API function associated with at least one service level parameter, and obtaining the at least one service level parameter from a response of the service in reaction to the API function call.

3. The method as claimed in claim 2, wherein the at least one service level parameter is obtained from one or more of the group consisting of: a completion time of the response; a return value received in reaction to the API function call; and a failure rate of the API function call, and wherein the method further includes maintaining a log of one or more of API function calls, data included in API function calls, and data returned from an API function call.

4. (canceled)

5. The method as claimed in claim 1, wherein the at least one service level parameter is obtained by extracting service level agreement data extracted from an agreement in which the external third party agrees to provide a level of service defined in terms of the service level parameters.

6. The method as claimed in claim 1 wherein quantifying risks includes quantifying the potential losses in dealing with the service by using a machine learning algorithm to dynamically estimate consequences associated with the service level parameters.

7. The method as claimed in claim 1 wherein generating a parametric distribution includes using a machine learning algorithm dynamically to estimate operational consequences associated with the service level parameters.

8. The method as claimed in claim 1 wherein monitoring the level of service associated with the distributed service includes one or more of: monitoring service uptime, monitoring service downtime, and executing a machine learning algorithm configured to observe delivery patterns associated with the service and to determine an expected service lead time based on the observed delivery patterns.

9. The method as claimed in claim 1 wherein the notification is configured to trigger connection of an alternative centralized or decentralized distributed service to the client devices, includes dynamically identifying another external third party providing the same service and automatically switching connection to the identified service according to configured rules.

10. The method as claimed in claim 1 including: arbitrating to evaluate one or more service level parameters and to identify the service which best meets these requirements, including quantifying a breach in a service level parameter and quantifying a cost of switching from one service to another.

11. The method as claimed in claim 1 wherein the service is configured for machine-to-machine interaction over a communication network.

12. The method as claimed in claim 1 wherein the decentralized service is a blockchain-based or peer-to-peer-based service; and wherein the centralized service is a cloud-based or remotely accessible service.

13. The method as claimed in claim 1 used in at least partial execution of a smart contract.

14. The method as claimed in claim 1 including providing a user interface associated with the distributed computing platform for monitoring and/or developing centralized and/or decentralized software applications.

15. A system including a distributed computing platform having a memory for storing computer-readable program code and a processor for executing the computer-readable program code, the distributed computing platform being accessible to client devices of an organization via a communication network and the distributed computing platform configured to facilitate access to a centralized or decentralized distributed service by the client devices, the service being provided by an external third party, the system comprising:
a service level parameter obtaining component for obtaining service level parameters for the service;
a risk quantifying component for quantifying risks associated with each parameter;
a parametric distribution generating component for generating a parametric distribution based on the quantified risks;
an access component for providing access to the parametric distribution to a digital platform, the digital platform being remotely accessible to external third parties;
a centralized component adapter for interfacing with centralized services;
a decentralized component adapter for interfacing with decentralized services;
a service level monitoring component for monitoring the level of service associated with the distributed service via the centralized or decentralized component adapter and for detecting that a service level parameter is breached; and
an action component for transmitting a notification of the breach to the remotely accessible digital platform for on forwarding to a selected external third party, the notification being configured to trigger connection of an alternative centralized or decentralized distributed service to the client devices.

16. The system as claimed in claim 15, wherein the service level parameter obtaining component includes an Application Programming Interface (API) component for calling an API function associated with at least one service level parameter, and obtaining the at least one service level parameter from a response of the service in reaction to the API function call.

17. (canceled)

18. (canceled)

19. (canceled)

20. (canceled)

21. The system as claimed in claim 15 wherein the notification is configured to trigger connection of an alternative centralized or decentralized distributed service to the client devices and the system includes a service switching component for dynamically identifying another external third party providing the same service and automatically switching connection to the identified service according to configured rules.

22. The system as claimed in claim 15 including: an arbitrating engine to evaluate one or more service level parameters and to identify the service which best meets these requirements, including quantifying a breach in a service level parameter and quantifying a cost of switching from one service to another.

23. (canceled)

24. (canceled)

25. The system as claimed in claim 15 including a smart contract design tool and using the service in at least partial execution of a smart contract.

26. The system as claimed in claim 15 including a user interface associated with the distributed computing platform for monitoring and/or developing centralized and/or decentralized software applications.

27. A computer program product for service level risk management to be conducted by an operating system executing on a distributed computing platform, wherein the distributed computing platform is accessible to client devices of an organization via a communication network and wherein the distributed computing platform facilitates access to a centralized or decentralized distributed service by the client devices, the service being provided by an external third party, the computer program product comprising a computer-readable medium having stored computer-readable program code for performing the steps of:
obtaining service level parameters for the service, including estimating parameters of an expected service level based on historical data stored in the memory;
quantifying risks associated with each parameter and generating a parametric distribution based on the quantified risks;
providing access to the parametric distribution to a digital platform, the digital platform being accessible to external third parties;
monitoring the level of service associated with the distributed service via a centralized or decentralized component adapter; and,
in response to detecting that a service level parameter is breached, transmitting a notification of the breach to the digital platform for on forwarding to a selected external third party, the notification being configured to trigger connection of an alternative centralized or decentralized distributed service to the client devices.
